(19) United States
(12) Patent Application Publication
(10) Pub. No.: US 2013/0299741 A1
(43) Pub. Date: Nov. 14, 2013

(54) LIQUID CRYSTAL MEDIUM COMPOSITION

(71) Applicant: Xinhui Zhong, Shenzhen (CN)

(72) Inventor: Xinhui Zhong, Shenzhen (CN)

(73) Assignee: Shenzhen China Star Optoelectronics Technology Co. Ltd., Shenzhen (CN)

(21) Appl. No.: 13/520,796

(22) PCT Filed: May 21, 2012
(86) PCT No.: PCT/CN12/75824

§ 371 Date: Jul. 6, 2012

(30) Foreign Application Priority Data
May 9, 2012 (CN) 201210142216.2

(51) Int. Cl. C09K 19/54

(52) U.S. Cl. 252/299.5

(57) ABSTRACT

A liquid crystal medium composition includes negative type liquid crystal material, stabilizer, and reactive monomer capable of reacting when being irradiated by ultraviolet light; the amount of the reactive monomer is 5% to 85% by weight based on the total amount of the liquid crystal medium composition. The reactive monomer at least includes a single-polymerisable-group monomer having structure shown in the following Formula (1) and double-polymerisable-group monomer having structure shown in the following Formula (2), and the amount of the single-polymerisable-group monomer is 5% to 85% by mole based on the total amount of the reactive monomer. The single-polymerisable-group monomer or the multiple-polymerisable-group monomer is capable of being irradiated by ultraviolet light to allow for the polymerization reaction to form the polymer. Additionally, the reaction speed is moderate to prevent the polymer from being oversized and loosely piled up for high reaction speed.

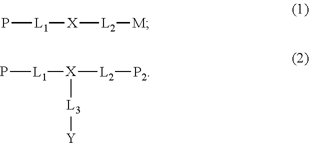

### BACKGROUND

1. Technical Field

The present disclosure relates to liquid crystal displaying technologies and, particularly, to a liquid crystal medium composition for a liquid crystal display.

2. Description of Related Art

Liquid crystals used in twisted nematic liquid crystal displays (SN LCDs) or super twisted nematic liquid crystal displays (STN LCDs) are positive type liquid crystals. In a STN LCD, an electric field is applied to change arrangement of liquid crystal molecules originally twisted by 180 degrees such that optical rotation states of the liquid crystal molecules can be changed. A long axis of each of the liquid crystal molecules is parallel with surfaces of substrates of the LCD when no voltage is applied to the positive type liquid crystals. The arrangement direction of the liquid crystal molecules on the surfaces of the substrates are decided by friction direction of the alignment layer. Since the alignment directions on surfaces of the two substrates are perpendicular to each other, the liquid crystal molecules of the liquid crystal layer between the two substrates are arranged in continuously twisted state. After the voltage is applied to the liquid crystals, the long axes of the liquid crystal molecules are arranged along the direction of the electric field. Viewing angles of the TN LCD and STN LCD are small. When enlarging the viewing angles of the two types of LCD, brightness difference and chromatism of the corresponding LCD will be worsened, thus, the brightness difference and the chromatism of the LCD may need to be improved via a compensation film, which increases the manufacturing cost of the LCD.

A LCD having Multi-domain vertical alignment (MVA) type thin film transistors (TFTs) is capable of providing large viewing angles which overcomes the problem that the viewing angles of the TN LCD and STN LCD are small. This type of LCD is made of negative type liquid crystal material and homeotropic alignment film material. When no voltage is applied to this type of LCD, the long axes of the liquid crystal molecules are perpendicular to the surfaces of the substrates thereof. After the voltage is applied to the LCD, the liquid crystal molecules tilt and the long axes thereof are arranged along the direction of the vertical electric field. In order to enlarge the viewing angle of the LCD, each sub-pixel of the LCD is divided into several regions to allow the liquid crystal molecules to tilt towards different directions, thus, the LCD can be viewed from different angles.

The following methods can be implemented to allow the liquid crystal molecules in different regions of each sub-pixel to tilt towards different directions. In a first method, bumps can be produced on an upper substrate and a lower substrate of the LCD by an exposure process and a developing process, thus, pre-tilt angles of the liquid crystal molecules around the bump can be formed to guide the liquid crystal molecules to tilt towards predetermined directions, as shown in FIG. 1(a). In a second method, using patterned vertical alignment (PVA) technology; that is, forming an ITO pixel electrode having a predetermined pattern on the upper substrate and the lower substrate to allow the electric field to have a predetermined tilt angle. Thus, the tilting directions of the liquid crystal molecules of different regions can be controlled, as shown in FIG. 1(b). In a third method, using polymer stabilized vertical alignment (PSVA) technology; that is, forming an ITO slit on the TFT array substrate of the LCD. At this time, another side of the LCD is FULL ITO. Monomer capable of being polymerized after being irradiated by ultraviolet light is added to the liquid crystal medium composition. The liquid crystal molecules are tilted by the electric field at first. After that, the liquid crystal panel is irradiated by ultraviolet light to allow for the polymerization reaction of the monomer, which produces the bump capable of guiding the liquid crystal molecules to tilt. In this way, the bump can be used as alignment by being deposited on the surfaces of the substrates, as shown in FIG. 2.

Using the above PSVA technology, the process of producing the bump via the polymerization reaction of the monomer is a separating process. Before the polymerization reaction, the monomer is a small molecule which has higher compatibility with the liquid crystal material. After being irradiated by ultraviolet light, the polymerization reaction occurs to form high molecular polymer. The high molecular polymer is separable from the liquid crystal material to produce the bump which is incompatible with the liquid crystal material. The bump is capable of guiding the liquid crystal molecules to tilt and thus capable of guiding the liquid crystal molecules. Using the PSVA technology, the critical point lies in controlling the reaction speed of the monomer to allow the bump of appropriate size to be produced in the polymerization reaction. Thus, the alignment of the liquid crystal molecules can be improved to allow the liquid crystal panel to have good optical property such as high contrast and high response speed.

The monomer used in the conventional PSVA technology often includes two polymerisable groups, which allows the reaction speed thereof to be higher than that of the monomer with only one polymerisable group. Also, the number of the polymer molecules formed by the monomer having two polymerisable groups is relatively larger, which allows the molecules to be separated out of the liquid crystal medium composition to form the bump easily. However, using the monomer with two polymerisable groups, bright spots visible in dark state are easily generated on the PSVA panel, as shown in FIG. 3, which reduces the contrast of the liquid crystal panel. As shown in FIG. 4, the polymer formed in the polymerization reaction of the monomer is over-sized and loosely piled up, which results in the disarrangement of the liquid crystal molecules and further results in the bright spots visible in the dark state.

As shown in FIG. 5, the principle causing the oversized and loosely piled up bump to be produced in the polymerization reaction of the monomer is schematically shown. Generally, it requires only one polymerisable group (namely two reactive points) for the monomer to react to generate a polymer chain. If the monomer includes two (namely four reactive points) or more polymerisable groups, a number of unreacted polymerisable groups may exist in the polymer chain. The unreacted polymerisable groups may cause further polymerization reactions or may be involved in other polymerization reactions, which may result in the production of the bumps having large sizes and being loosely piled up as shown in FIG. 4.

### SUMMARY

One object of the present disclosure is to provide a liquid crystal medium composition for a liquid crystal display (LCD), which is capable of preventing undesirable liquid crystal alignment which may cause bright spots visible in dark state of the liquid crystal panel and is capable of improving the contrast and optical effect of the LCD.

The liquid crystal medium composition, includes negative type liquid crystal material, stabilizer, and reactive monomer capable of reacting when being irradiated by ultraviolet light; the amount of the reactive monomer is 5% to 85% by weight based on the total amount of the liquid crystal medium composition; the reactive monomer includes single-polymerisable-group monomer having structure shown in the following Formula (1) and double-polymerisable-group monomer having structure shown in the following Formula (2), and the amount of the single-polymerisable-group monomer being 5% to 85% by mole based on the total amount of the reactive monomer;

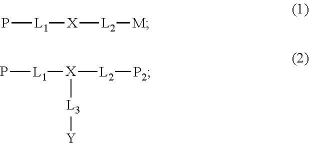

in the Formula (1), P is a polymerisable group, L1 and L2 are linking groups, X is a core group, M is a straight chain alkyl or branched alkyl respectively having 1 to 7 carbon atoms, or a hydrogen atom;

in the Formula (2), P1 and P2 are polymerisable groups, L1, L2, and L3 are linking groups, X is the core group, Y is a group selected from the group consisting of the polymerisable group P1, the polymerisable group P2, straight chain alkyl or branched alkyl respectively having 1 to 7 carbon atoms, and hydrogen atom.

Preferably, in the Formula (1), the structure of the core group X is selected from the group consisting of:

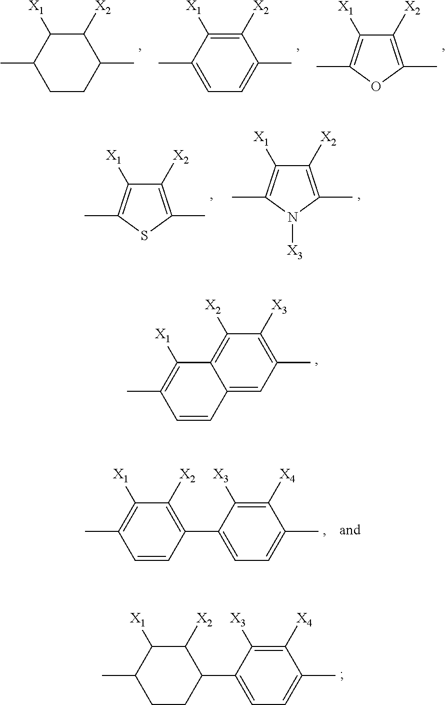

in the above structures, X1, X2, X3, X4 of the core group X are substituent groups, the substituent group X1 is selected from the group consisting of H, F, Cl, Br, CN, and methyl, the substituent group X2 is selected from the group consisting of H, F, Cl, Br, CN, and methyl, the substituent group X3 is selected from the group consisting of H, F, Cl, Br, CN, and methyl group, the substituent group X4 is selected from H, F, Cl, Br, CN, and methyl.

Preferably, the structure of the core group X is selected from the following group consisting of:

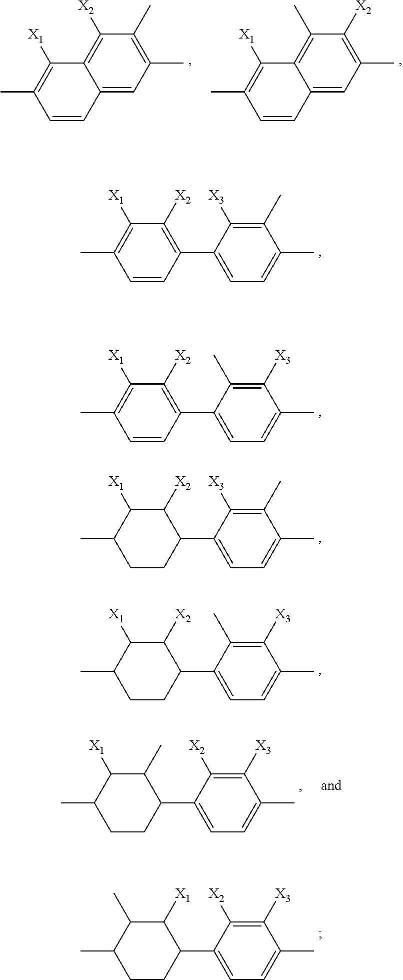

in the above structures, X1, X2, and X3 of the core group X are substituent groups, the substituent group X1 is selected from the group consisting of H, F, Cl, Br, CN, and methyl; the substituent group X2 is selected from the group consisting of H, F, Cl, Br, CN, and methyl group; and the substituent group X3 is selected from the group consisting of H, F, Cl, Br, CN, and methyl.

Preferably, the polymerisable group in the Formula (1) is selected from the group consisting of methyl acrylate, acrylic ester, vinyl, ethylene oxygen radicals, and epoxy resin.

Preferably, the structure of the core group X is selected from the following group consisting of:

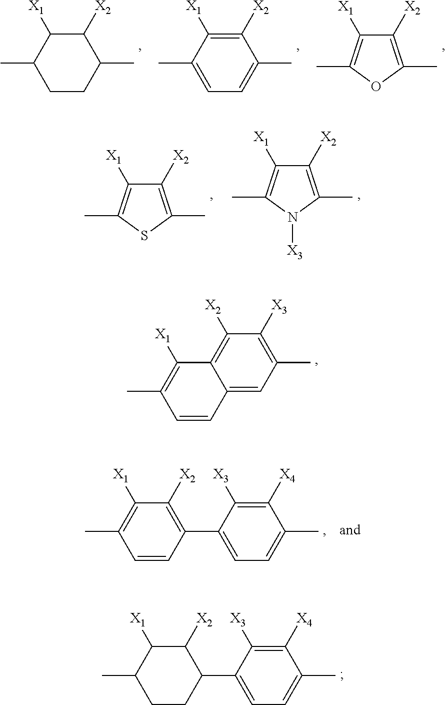

in the above structures, X1, X2, X3, X4 of the core group X are substituent groups, the substituent group X1 is selected from the group consisting of H, F, Cl, Br, CN, and methyl; the substituent group X2 is selected from the group consisting of H, F, Cl, Br, CN, and methyl; the substituent group X3 is selected from the group consisting of H, F, Cl, Br, CN, and methyl; and the substituent group X4 is selected from the group consisting of H, F, Cl, Br, CN, and methyl.

Preferably, the linking group L1 in the Formula (1) is selected from the group consisting of a carbon-to-carbon bond, —O—, —COO—, —OCO—, —CH₂O—, —OCH₂O—, —O(CH₂)₂O—, —COCH₂—, and methylene.

Preferably, the linking group L2 in the Formula (1) is selected from the group consisting of a carbon-to-carbon bond, —O—, —COO—, —OCO—, —CH₂O—, —OCH₂O—, —O(CH₂)₂O—, —COCH₂—, and methylene.

Preferably, the structure of the core group X is selected from the following group consisting of:

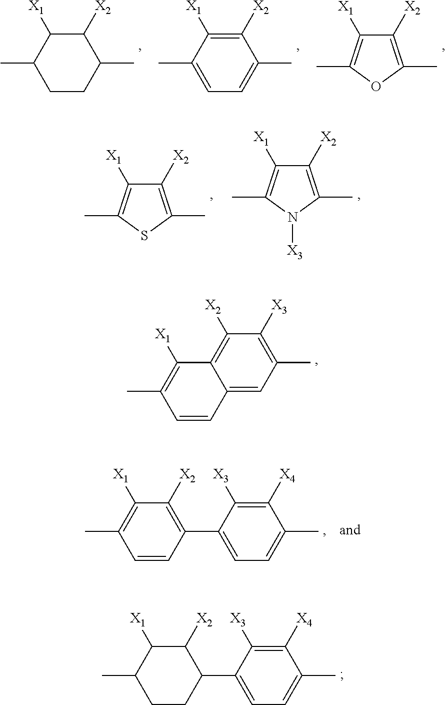

in the above structures, X1, X2, X3, X4 of the core group X are substituent groups, the substituent group X1 is selected from the group consisting of H, F, Cl, Br, CN, and methyl group; the substituent group X2 is selected from the group consisting of H, F, Cl, Br, CN, and methyl; the substituent group X3 is selected from the group consisting of H, F, Cl, Br, CN, and methyl group; and the substituent group X4 is selected from the group consisting of H, F, Cl, Br, CN, and methyl.

Preferably, the polymerisable group P1 in the Formula (2) is selected from the group consisting of methyl acrylate, acrylic ester, vinyl, ethylene oxygen radicals, and epoxy resin; and the polymerisable group P2 in the Formula (2) is selected from the group consisting of acrylate, acrylic ester, vinyl, ethylene oxygen radicals, and epoxy resin.

Preferably, the structure of the core group X is selected from the following group consisting of:

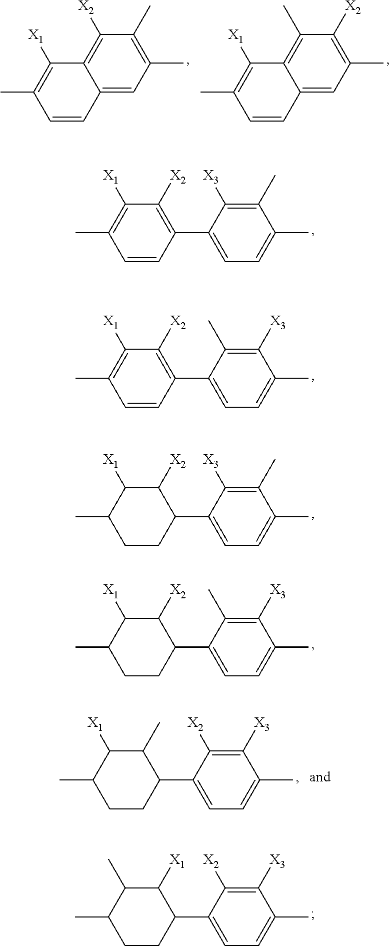

in the above structures, X1, X2, and X3 of the core group X are substituent groups, the substituent group X1 is selected from the group consisting of H, F, Cl, Br, CN, and methyl; the substituent group X2 is selected from the group consisting of H, F, Cl, Br, CN and methyl, and the substituent group X3 is selected from the group consisting of H, F, Cl, Br, CN, and methyl.

Preferably, the linking group L1 in the Formula (1) is selected from the group consisting of a carbon-to-carbon bond, —O—, —COO—, —OCO—, —CH₂O—, —OCH₂O—, —O(CH₂)₂O—, —COCH₂—, and methylene.

Preferably, the linking group L2 in the Formula (2) is selected from the group consisting of a carbon-to-carbon bond, —O—, —COO—, —OCO—, —CH₂O—, —OCH₂O—, —O(CH₂)₂O—, —COCH₂—, and a methylene.

Preferably, the linking group L3 in the Formula (2) is selected from the group consisting of a carbon-to-carbon bond, —O—, —COO—, —OCO—, —CH₂O—, —OCH₂O—, —O(CH₂)₂O—, —COCH₂—, and methylene.

Preferably, the structure of the core group X is selected from the following group consisting of:

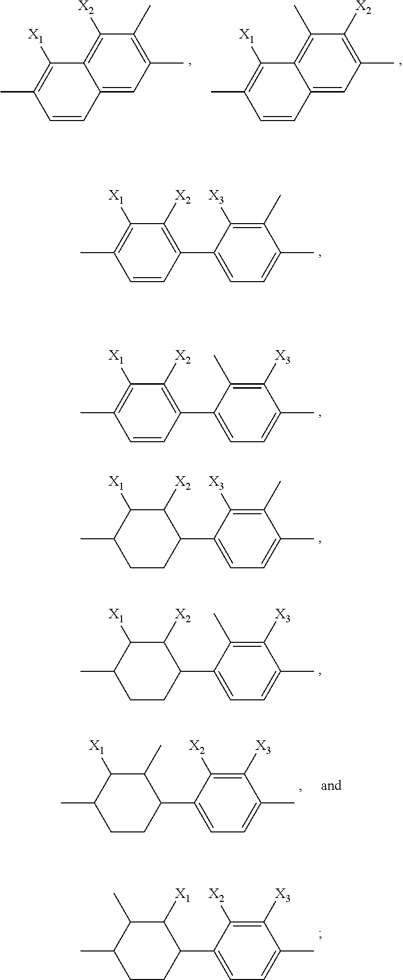

in the above structures, X1, X2, and X3 of the core group X are substituent groups, the substituent group X1 is selected from the group consisting of H, F, Cl, Br, CN, and methyl; the substituent group X2 is selected from the group consisting of H, F, Cl, Br, CN, and methyl; and the substituent group X3 is selected from the group consisting of H, F, Cl, Br, CN, and methyl.

Preferably, the structure of the stabilizer is shown in the following formula:

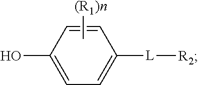

in the above formula, R₁ is a straight chain alkyl or branched alkyl having 1 to 9 carbon atoms, n is an integer ranging from 1 to 4; when n>1, there are many substituent groups R₁ of same structure or different structures in each of ring structure, R₂ is a straight chain alkyl or branched alkyl having 1 to 36 carbon atoms, and L is selected from the group consisting of a carbon-to-carbon bond, —O—, —COO—, —OCO—, —CH2O—, —OCH2O—, —O(CH2)2O—, —COCH2-, and methylene.

Preferably, the liquid crystal material includes at least one kind of liquid crystal molecule having structure shown in the following formula:

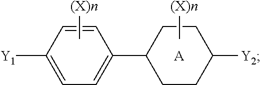

in the above formula,

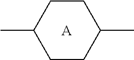

can be

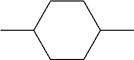

or

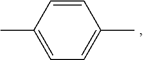

X is the substituent group connected to the ring structure, and n is an integer ranging from 1 to 4; n is varied in different ring structures; when n>1, there are many substituent groups X of same structure or different structures in each of ring structure; the substituent group X is selected from the group consisting of —H, —F, —Cl, —Br, —I, —CN, and —NO₂; Y₁ and Y₂ are independently selected from the group consisting of —R, —O—R, —CO—R, —OCO—R, —COO—R, and —(OCH₂CH₂)ₙ₁CH₃; R is a straight chain alkyl or branched alkyl having 1 to 12 carbon atoms; n1 is an integer ranging from 1 to 5, and Y₁ is the same as Y₂ or different from Y₂.

Preferably, the stabilizer includes component shown the following formula:

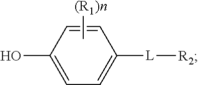

in the above formula, R₁ is the straight chain alkyl or branched alkyl having 1 to 9 carbon atoms, and n is an integer ranging from 1 to 4; When n>1, there are many substituent groups R₁ of same structure or different structure in each of benzene ring structure; R₂ is a straight chain alkyl or branched alkyl having 1 to 36 carbon atoms, and L is selected from the group consisting of a carbon-to-carbon bond, —O—, —COO—, —OCO—, —CH₂O—, —OCH₂O—, —O(CH₂)₂O—, —COCH₂—, and methylene.

Another object of the present disclosure is to provide another liquid crystal medium composition. The liquid crystal medium composition includes negative type liquid crystal material, the negative type liquid crystal material comprising at least one kind of liquid crystal molecule having structure shown in the following formula:

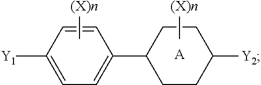

in the above formula,

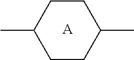

can be

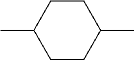

or

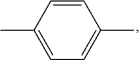

X is the substituent group connected to the ring structure, and n is an integer ranging from 1 to 4; different ring structures have different n; when n>1, there are many substituent groups X of same structure or different structures in each of ring structure; the substituent group X is selected from the group consisting of —H, —F, —Cl, —Br, —I, —CN, and —NO₂; Y₁ and Y₂ are independently selected from the group consisting of —R, —O—R, —CO—R, —OCO—R, —COO—R, and —(OCH₂CH₂)ₙ₁CH₃; and Y₁ is the same as Y₂ or different from Y₂.

Preferably, the substituent group is selected from the group consisting of —H, —F, —Cl, —Br, —I, —CN, and —NO₂.

Preferably, R is a straight chain alkyl or branched alkyl having 1 to 12 carbon atoms, and n is an integer ranging from 1 to 5.

The single-polymerisable-group monomer or the multiple-polymerisable-group monomer of the liquid crystal medium composition of the present disclosure is capable of being irradiated by ultraviolet light to allow for the polymerization reaction to form the polymer. Additionally, the reaction speed is moderate, which is capable of preventing the situation that the polymer is oversized and loosely piled up for high reaction speed. Thus, undesirable liquid crystal alignment of the LCD and bright spots visible in dark state of the liquid crystal panel can be prevented, which improves the contrast and the optical effect of the LCD.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view showing state of liquid crystal medium composition after liquid crystal alignment process of a conventional liquid crystal display (LCD);

FIG. 2 is a schematic view showing the liquid crystal alignment process of the LCD of FIG. 1;

FIG. 3 is a schematic view showing the state of the liquid crystal panel after the liquid crystal alignment process of the LCD of FIG. 1;

FIG. 4 is a schematic view showing the arrangement state of liquid crystal molecules after the liquid crystal alignment process of the LCD of FIG. 1;

FIG. 5 is a schematic view showing the process of the polymerization reaction of the monomer in the liquid crystal alignment process of the LCD of FIG. 1.

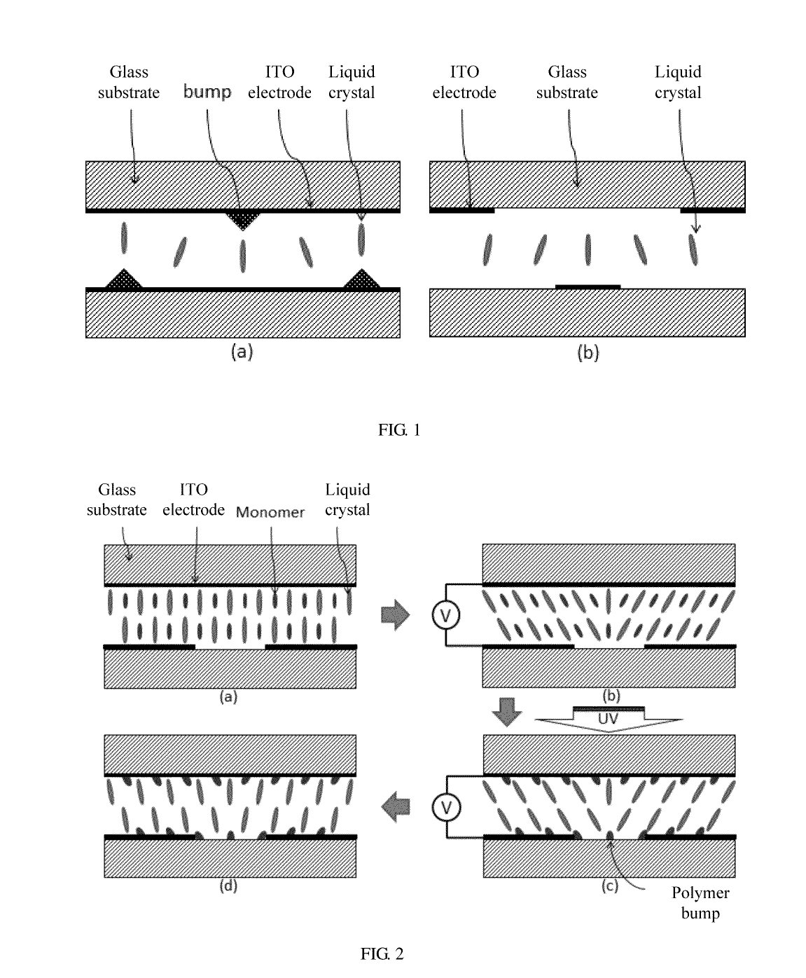

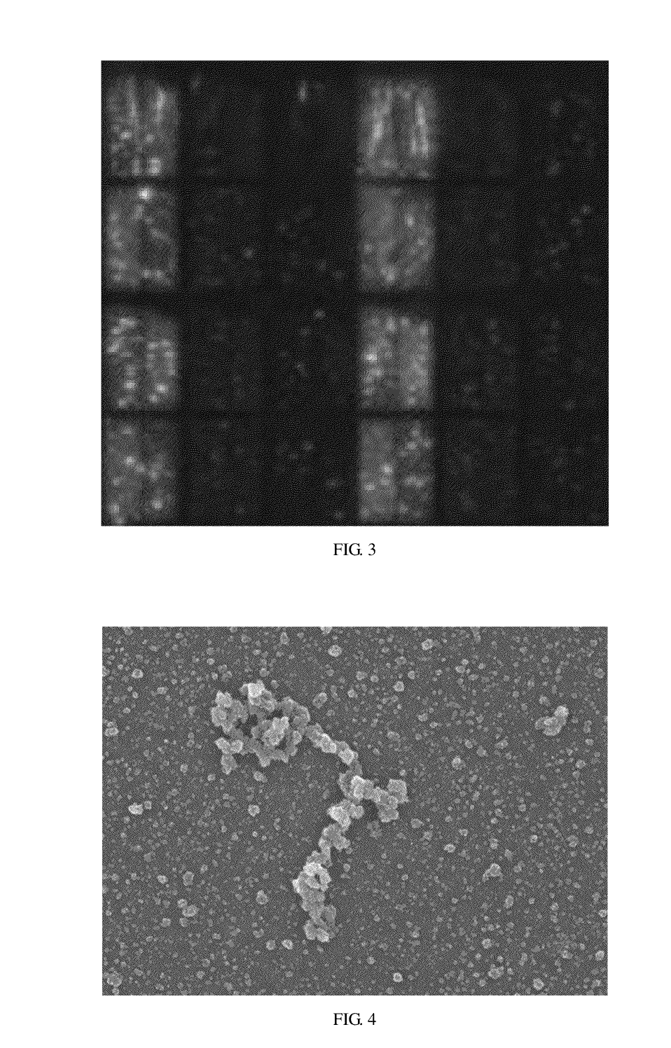

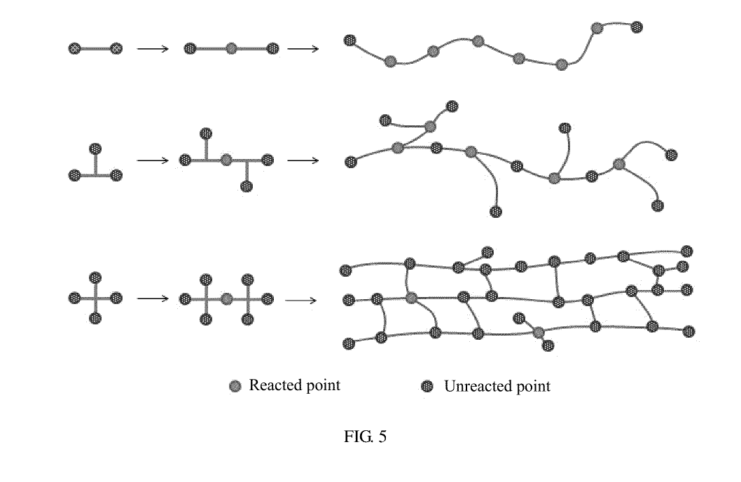

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

### First Embodiment

The amount of each component in the first embodiment is given according to the amount specified in Table One and Table two.

Step One: adding single-polymerisable-group monomer having structure shown in the following Formula (3) and double-polymerisable-group monomer having structure shown in the following Formula (4) to the mixture of negative type liquid crystal material and stabilizer to form an uniform liquid crystal medium composition. Tₙᵢ of the negative type liquid crystal material is 75 centigrade, Δn thereof is 0.095(25° C., 589 nm), and Δε thereof is −2.8 (25° C., 1 kHz).

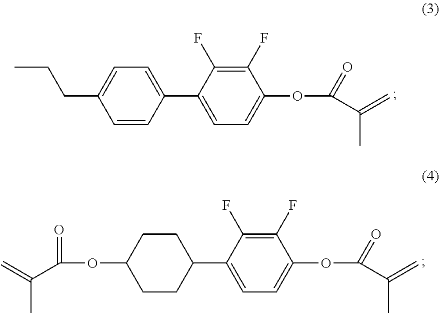

in the above Formula (3), molecular weight of the single-polymerisable-group monomer is 316, and in the above Formula (4), the molecular weight of the double-polymerisable-group monomer is 364.

Step Two, dropping the liquid crystal medium manufactured according to step One on a thin film transistor array substrate using an ODF method, combining the thin film transistor array substrate and a color filter substrate, and curing the sealant to form the liquid crystal panel.

Step three, applying an AC square wave voltage of 20 volts and 60 HZ onto the liquid crystal panel manufactured according to step Two, irradiating the liquid crystal panel by ultraviolet light having a main wavelength ranging from 300 nm to 350 nm, which allows for a copolymerization reaction of the monomer in the liquid crystal medium composition to form the polymer for aligning the liquid crystal molecules. The property of the liquid crystal panel then is detected according to standards shown in Table one, and the detecting result is also shown in Table one.

### Second Embodiment

The amount of each component in the second embodiment is given according to the amount specified in Table one and Table two.

Step One, adding single-polymerisable-group monomer having structure shown in the following Formula (5) and three-polymerisable-group monomer having structure shown in the following Formula (6) into the mixture of negative type liquid crystal material and stabilizer to form the uniform liquid crystal medium composition. Tₙᵢ of the negative type liquid crystal material is 75 centigrade, Δn thereof is 0.095(25° C., 589 nm), and Δε thereof is −2.8 (25° C., 1 kHz).

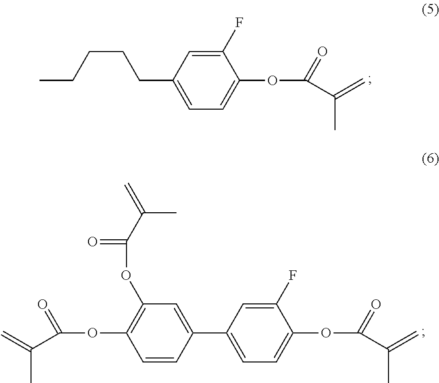

in the above Formula (5), the molecular weight of the single-polymerisable-group monomer is 250, and in the above Formula (6), the molecular weight of the three-polymerisable-group monomer is 424.

Step Two, dropping the liquid crystal medium composition formed according to step One on a thin film transistor array substrate using an ODF method, combining the thin film transistor array substrate and a color filter substrate, and curing the sealant to form the liquid crystal panel.

Step Three, applying an AC square wave voltage of 20 volts and 60 HZ onto the liquid crystal panel formed according to step Two, irradiating the liquid crystal panel by ultraviolet light having main wavelength ranging from 300 nm to 350 nm, which allows for a copolymerization reaction of the monomer in the liquid crystal medium composition to produce the polymer for aligning the liquid crystal molecules. The property of the liquid crystal panel then is detected according to the standards shown in Table one, and the detecting result is also shown in Table one.

### Third Embodiment

The amount of each component in the third embodiment is given according to the amount specified in Table one and Table two.

Step One, adding the single-polymerisable-group monomer having structure shown in the following Formula (7), double-polymerisable-group monomer having structure shown in the following Formula (8), and three-polymerisable-group monomer having structure shown in the following Formula (9) into the mixture of negative type liquid crystal material and stabilizer to form the uniform liquid crystal medium composition. Tₙᵢ of the negative type liquid crystal material is 75 centigrade, Δn thereof is 0.095(25° C., 589 nm), and Δε thereof is −2.8 (25° C., 1 kHz).

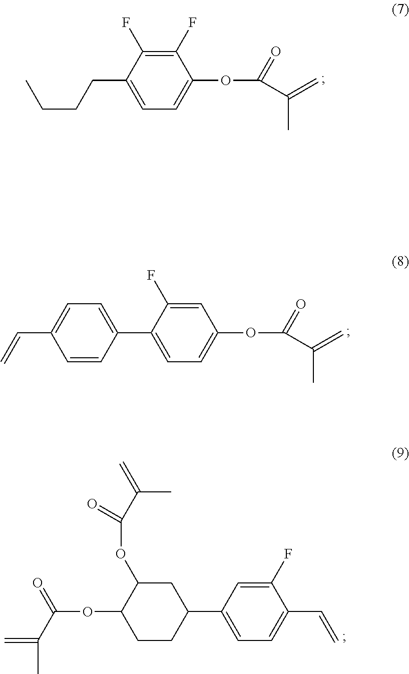

In the above Formula (7), the molecular weight of the single-polymerisable-group monomer is 254; in the above Formula (8), the molecular weight of the double-polymerisable-group monomer is 282, and in the above Formula (9), the molecular weight of the three-polymerisable-group monomer is 372.

Step Two, dropping the liquid crystal medium composition formed according to step One on a thin film transistor array substrate using an ODF method, combining the thin film transistor array substrate and a color filter substrate, and curing the sealant to form the liquid crystal panel.

Step Three, applying an AC square wave voltage of 20 volts and 60 HZ onto the liquid crystal panel formed according to step Two, irradiating the liquid crystal panel by ultraviolet light having a main wavelength thereof ranging from 300 nm to 350 nm, which allows for a copolymerization reaction of the monomer in the liquid crystal medium composition to produce the polymer for aligning the liquid crystal molecules. The property of the liquid crystal panel then is detected according to the standards shown in Table one, and the detecting result is also shown in Table one.

### Forth Embodiment

The amount of each component in the forth embodiment is given according to the amount specified in Table one and Table two.

Step One, adding the single-polymerisable-group monomer having structure shown in the following Formula (10), double-polymerisable-group monomer having structure shown in the following Formula (11), and three-polymerisable-group monomer having structure shown in following Formula (12) into the mixture of negative type liquid crystal material and stabilizer to form the uniform liquid crystal medium composition. Tₙᵢ of the negative type liquid crystal material is 75 centigrade, Δn thereof is 0.095(25° C., 589 nm), and Δε thereof is −2.8 (25° C., 1 kHz).

In the above Formula (10), the molecular weight of the single-polymerisable-group monomer is 334; in the above Formula (11), the molecular weight of the double-polymerisable-group monomer is 282, and in the above Formula (12), the molecular weight of the three-polymerisable-group monomer is 372.

Step Two, dropping the liquid crystal medium composition formed according to step One on a thin film transistor array substrate using an ODF method, combining the thin film transistor array substrate and a color filter substrate, and curing the sealant to form the liquid crystal panel.

Step Three, applying an AC square wave voltage of 20 volts and 60 HZ onto the liquid crystal panel formed according to step Two, irradiating the liquid crystal panel by ultraviolet light having a main wavelength thereof ranging from 300 nm to 350 nm, which allows for a copolymerization reaction of the monomer in the liquid crystal medium composition to produce the polymer for aligning the liquid crystal molecules. The property of the liquid crystal panel then is detected according to the standards shown in Table one, and the detecting result is also shown in Table one.

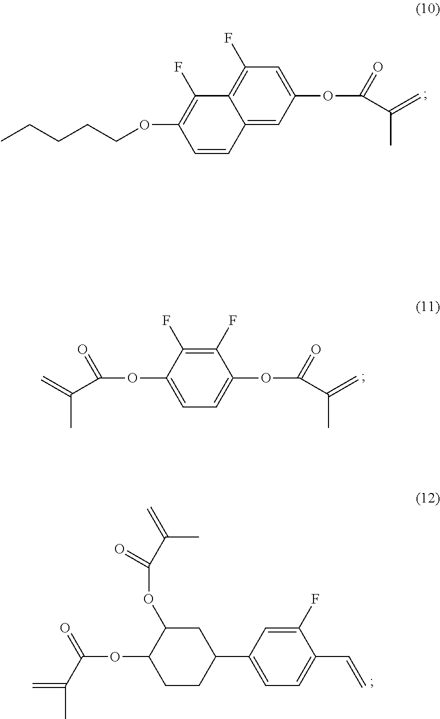

In the above Formula (10), the molecular weight of the single-polymerisable-group monomer is 254; in the above Formula (11), the molecular weight of the double-polymerisable-group monomer is 282, and in the above Formula (12), the molecular weight of the three-polymerisable-group monomer is 372.

Step Two, dropping the liquid crystal medium composition formed according to step One on a thin film transistor array substrate using an ODF method, combining the thin film transistor array substrate and a color filter substrate, curing the sealant to form the liquid crystal panel.

Step Three, applying an AC square wave voltage of 20 volts and 60 HZ onto the liquid crystal panel formed according to Step Two, irradiating the liquid crystal panel using ultraviolet light having a main wavelength thereof ranging from 300 nm to 350 nm, which allows for a copolymerization reaction of the monomer in the liquid crystal medium composition to form the polymer for aligning the liquid crystal molecules. The property of the liquid crystal panel then is detected according to the standards shown in Table one, and the detecting result is also shown in Table one.

### Fifth Embodiment

The amount of each component in the fifth embodiment is given according to the amount specified in Table one and Table two.

Step One, adding single-polymerisable-group monomer having structure shown in the following Formula (13), double-polymerisable-group monomer having structure shown in the following Formula (14), and three-polymerisable-group monomer having structure shown in the following Formula (15) into the mixture of negative type liquid crystal material and stabilizer to form the uniform liquid crystal medium composition. Tₙᵢ of the negative type liquid crystal material is 75 centigrade, Δn thereof is 0.095(25° C., 589 nm), and Δε thereof is −2.8 (25° C. 0.1 kHz).

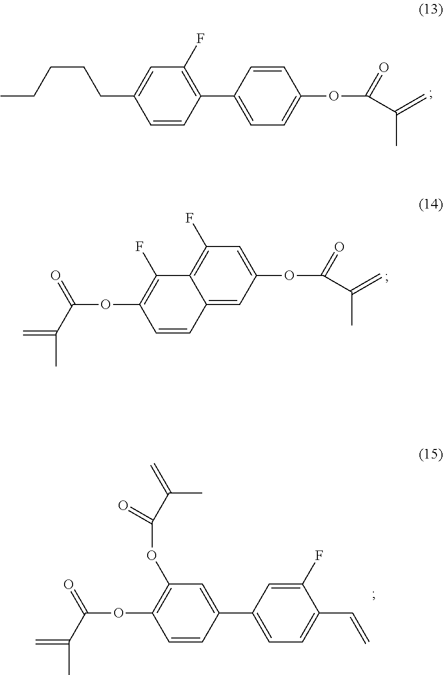

In the above Formula (13), the molecular weight of the single-polymerisable-group monomer is 326; in the above Formula (14), the molecular weight of the double-polymerisable-group monomer is 332, and in the above Formula (15), the molecular weight of the three-polymerisable-group monomer is 366.

Step Two, dropping the liquid crystal medium composition formed according to step One on a thin film transistor array substrate using an ODF method, combining the thin film transistor array substrate and a color filter substrate, and curing the sealant to form the liquid crystal panel.

Step Three, applying an AC square wave voltage of 20 volts and 60 HZ onto the liquid crystal panel formed according to Step Two, irradiating the liquid crystal panel by ultraviolet light having a main wavelength ranging from 300 nm to 350 nm, which allows for a copolymerization reaction of the monomer in the liquid crystal medium composition to produce the polymer for aligning the liquid crystal molecules. The property of the liquid crystal panel then is detected according to the standards shown in Table one, and the detecting result is also shown in Table one.

### Compared Embodiment

The amount of each component in the compared embodiment is given according to the amount specified in Table one and Table two.

Step One, adding double-polymerisable-group monomer having structure shown in the following Formula (16) into the mixture of negative type liquid crystal material and stabilizer to form the uniform liquid crystal medium composition. Tₙᵢ of the negative type liquid crystal material is 75 centigrade, Δn thereof is 0.095(25° C., 589 nm), and Δε thereof is −2.8 (25° C., 1 kHz).

In the above Formula (16), the molecular weight of the double-polymerisable-group monomer is 340.

Step Two, dropping the liquid crystal medium composition formed according to step One on a thin film transistor array substrate using an ODF method, combining the thin film transistor array substrate and a color filter substrate, and curing the sealant to form the liquid crystal panel.

Step Three, applying an AC square wave voltage of 20 volts and 60 HZ onto the liquid crystal panel formed according to Step Two, irradiating the liquid crystal panel by ultraviolet light having a main wavelength ranging from 300 nm to 350 nm, which allows for a copolymerization reaction of the monomer in the liquid crystal medium composition to produce the polymer for aligning the liquid crystal molecules. The property of the liquid crystal panel then is detected according to the standards shown in Table one, and the detecting result is also shown in Table one.

The negative type of liquid crystal material in the above embodiments and the compared embodiment includes liquid crystal molecules having structure shown the following formula:

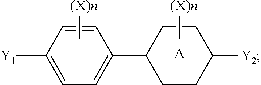

in the above formula,

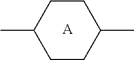

can be

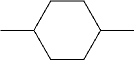

or

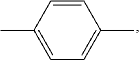

X is the substituent group connected to the ring structure, and n is an integer ranging from 1 to 4. Different ring structures have different n. When n>1, there are many substituent groups X of same structure or different structures in each of ring structure. The substituent group X can be selected from the group consisting of —H, —F, —Cl, —Br, —I, —CN, and —NO₂; Y₁ and Y₂ are independently selected from the group consisting of —R, —O—R, —CO—R, —OCO—R, —COO—R, and —(OCH₂CH₂)ₙ₁CH₃. R is a straight chain alkyl or branched alkyl having 1 to 12 carbon atoms, n1 is an integer ranging 1 to 5, and Y₁ can be the same as Y₂ or different from Y₂.

The stabilizer used in the above embodiments and the compared embodiment has the structure shown in the following formula:

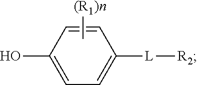

in the above formula, R₁ is the straight chain alkyl or branched alkyl having one to nine carbon atoms, and n is an integer ranging from 1 to 4. When n>1, there are many substituent groups R₁ of same structure or different structures in each of benzene ring structure. R₂ is a straight chain alkyl or branched alkyl having 1 to 36 carbon atoms, and L is selected from the group consisting of a carbon-to-carbon bond, —O—, —COO—, —OCO—, —CH₂O—, —OCH₂O—, —O(CH₂)₂O—, —COCH₂—, and methylene.

According to Table one, after adopting the liquid crystal medium composition provided in the above embodiments, the LCD is capable of providing a good liquid crystal alignment, a high contrast, and good optical effect without bright spots visible in dark state.

TABLE ONE

| | First | Second | Third | Forth | Fifth | Compared |
|---|---|---|---|---|---|---|
| | embodiment | embodiment | embodiment | embodiment | embodiment | embodiment |
| amount of the | 0.1% | 0.35% | 0.5% | 0.8% | 1% | 0.4% |
| monomer by weight | | | | | | |
| based on the total | | | | | | |
| amount of the liquid | | | | | | |
| crystal medium | | | | | | |
| composition | | | | | | |
| state of liquid crystal | Good | Very good | Very good | Good | Good | Good |
| alignment | | | | | | |
| whether there is any | No | no | no | no | no | Yes |
| bright spot visible in | | | | | | |
| dark state | | | | | | |
| contrast of the LCD | ~3200 | ~4200 | ~3800 | ~2800 | ~2500 | ~1400 |
| overall optical effect | good | Very good | Very good | good | good | bad |
| of the LCD | | | | | | |

TABLE TWO

| | | | First | Second | Third | Forth | Fifth | Compared |
|---|---|---|---|---|---|---|---|---|
| the amount of each component | | | embod- | embod- | embod- | embod- | embod- | embod- |
| by mole in the monomer | | | iment | iment | iment | iment | iment | iment |
| Polymerisable | Single-polymerisable- | | 5 | 30 | 50 | 70 | 85 | 0 |
| monomer | group monomer | | | | | | | |
| | Multiple- | Double- | 95 | 0 | 40 | 10 | 5 | 100 |
| | polymerisable- | polymerisable- | | | | | | |
| | group monomer | group monomer | | | | | | |
| | | Three- | 0 | 70 | 10 | 20 | 10 | 0 |
| | | polymerisable- | | | | | | |
| | | group monomer | | | | | | |

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A liquid crystal medium composition, wherein the liquid crystal medium composition comprises negative type liquid crystal material, stabilizer; and reactive monomer capable of reacting when being irradiated by ultraviolet light; the amount of the reactive monomer is 5% to 85% by weight based on the total amount of the liquid crystal medium composition; the reactive monomer comprises single-polymerisable-group monomer having structure shown in the following Formula (1) and double-polymerisable-group monomer having structure shown in the following Formula (2), and the amount of the single-polymerisable-group monomer is 5% to 85% by mole based on the total amount of the reactive monomer; 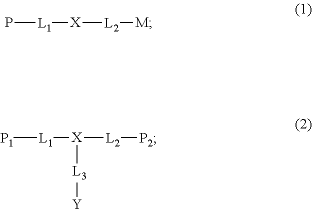
in the Formula (1), P is a polymerisable group, L1 and L2 are linking groups, X is a core group, M is a straight chain alkyl or branched alkyl having 1 to 7 carbon atoms, or a hydrogen atom;
in the Formula (2), P1 and P2 are polymerisable groups, L1, L2, and L3 are linking groups,
X is a core group, Y is a group selected from the group consisting of the polymerisable group P1, the polymerisable group P2, straight chain alkyl or branched alkyl independently having 1 to 7 carbon atoms, and hydrogen atom.

2. The liquid crystal medium composition as claimed in claim 1, wherein in the Formula (1) the structure of the core group X is selected from the group consisting of: 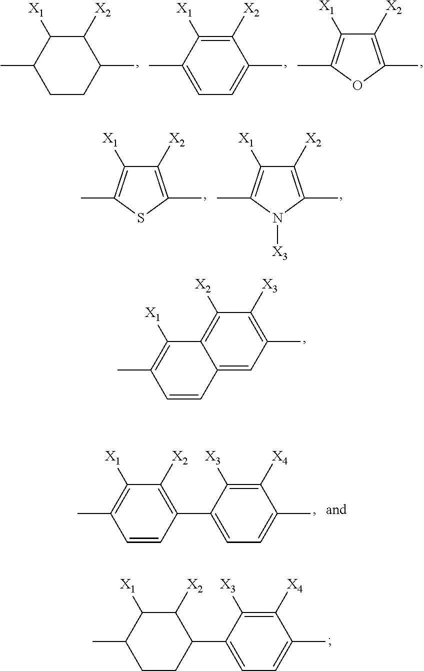
in the above examples, X1, X2, X3, X4 of the core group X are substituent groups, the substituent group X1 is selected from the group consisting of H, F, Cl, Br, CN, and methyl, the substituent group X2 is selected from the group consisting of H, F, Cl, Br, CN, and methyl, the substituent group X3 is selected from the group consisting of H, F, Cl, Br, CN, and methyl, the substituent group X4 is selected from H, F, Cl, Br, CN, and methyl.

3. The liquid crystal medium composition as claimed in claim 1, wherein the structure of the core group X is selected from the following group consisting of: 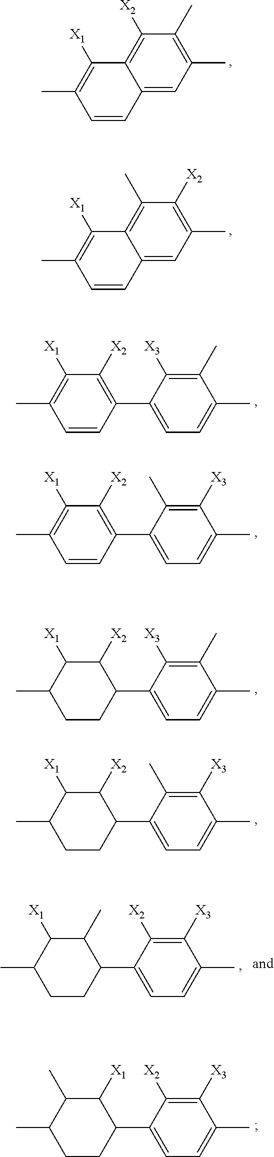
in the above structures, X1, X2, and X3 of the core group X are substituent groups, the substituent group X1 is selected from the group consisting of H, F, Cl, Br, CN, and methyl; the substituent group X2 is selected from the group consisting of H, F, Cl, Br, CN, and methyl; and the substituent group X3 is selected from the group consisting of H, F, Cl, Br, CN, and methyl.

4. The liquid crystal medium composition as claimed in claim 1, wherein the polymerisable group of Formula (1) is selected from the group consisting of methyl acrylate, acrylic ester, vinyl, ethylene oxygen radicals, and epoxy resin.

5. The liquid crystal medium composition as claimed in claim 4, wherein the structure of the core group X is selected from the following group consisting of: 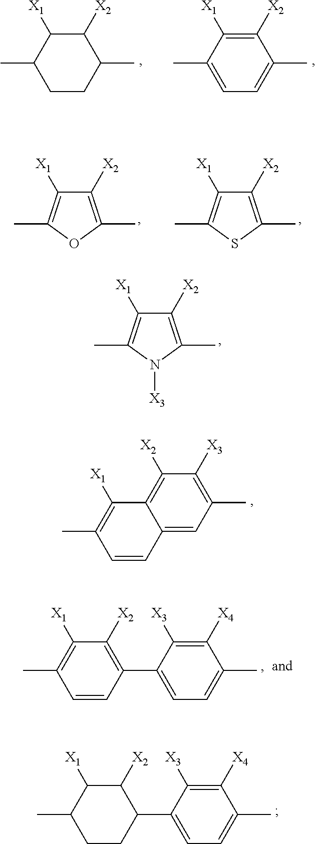
in the above structures, X1, X2, X3, X4 of the core group X are substituent groups, the substituent group X1 is selected from the group consisting of H, F, Cl, Br, CN, and methyl; the substituent group X2 is selected from the group consisting of H, F, Cl, Br, CN, and methyl; the substituent group X3 is selected from the group consisting of H, F, Cl, Br, CN, and methyl; and the substituent group X4 is selected from the group consisting of H, F, Cl, Br, CN, and methyl.

6. The liquid crystal medium composition as claimed in claim 1, wherein the linking group L1 in the Formula (1) is selected from the group consisting of a carbon-to-carbon bond, —O—, —COO—, —OCO—, —CH₂O—, —OCH₂O—, —O(CH₂)₂O—, —COCH₂—, and methylene.

7. The liquid crystal medium composition as claimed in claim 1, wherein the linking group L2 in the Formula (1) is selected from the group consisting of a carbon-to-carbon bond, —O—, —COO—, —OCO—, —CH₂O—, —OCH₂O—, —O(CH₂)₂O—, —COCH₂—, and methylene.

8. The liquid crystal medium composition as claimed in claim 6, wherein the structure of the core group X is selected from the following group consisting of: 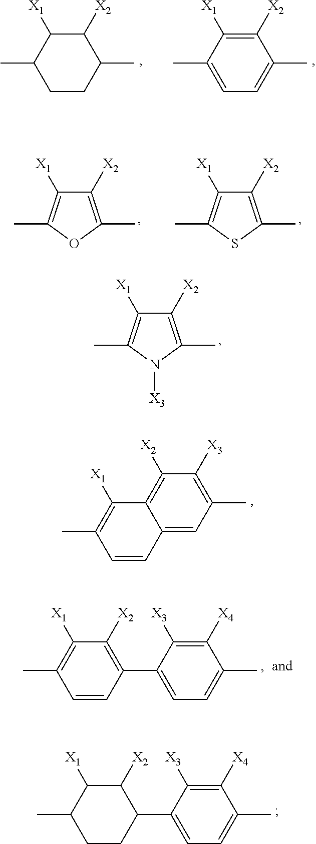
in the above structures, X1, X2, X3, X4 of the core group X are substituent groups, the substituent group X1 is selected from the group consisting of H, F, Cl, Br, CN, and methyl; the substituent group X2 is selected from the group consisting of H, F, Cl, Br, CN, and methyl; the substituent group X3 is selected from the group consisting of H, F, Cl, Br, CN, and methyl; and the substituent group X4 is selected from the group consisting of H, F, Cl, Br, CN, and methyl.

9. The liquid crystal medium composition as claimed in claim 1, wherein the polymerisable group P1 in the Formula (2) is selected from the group consisting of methyl acrylate, acrylic ester, vinyl, ethylene oxygen radicals, and epoxy resin; and the polymerisable group P2 in the Formula (2) is selected from the group consisting of acrylate, acrylic ester, vinyl, ethylene oxygen radicals, and epoxy resin.

10. The liquid crystal medium composition as claimed in claim 9, wherein the structure of the core group X is selected from the following group consisting of: 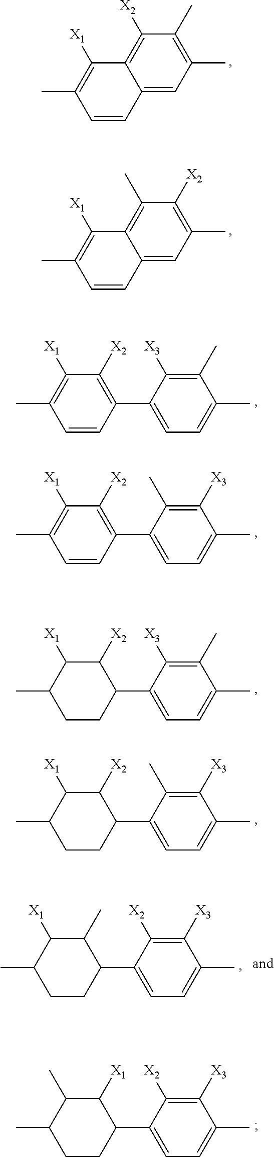
in the above structures, X1, X2, and X3 of the core group X are substituent groups, the substituent group X1 is selected from the group consisting of H, F, Cl, Br, CN, and methyl; the substituent group X2 is selected from the group consisting of H, F, Cl, Br, CN and methyl, and the substituent group X3 is selected from the group consisting of H, F, Cl, Br, CN, and methyl.

11. The liquid crystal medium composition as claimed in claim 1, wherein the linking group L1 in the Formula (1) is selected from the group consisting of a carbon-to-carbon bond, —O—, —COO—, —OCO—, —CH₂O—, —OCH₂O—, —O(CH₂)₂O—, —COCH₂—, and methylene.

12. The liquid crystal medium composition as claimed in claim 1, wherein the linking group L2 in the Formula (2) is selected from the group consisting of a carbon-to-carbon bond, —O—, —COO—, —OCO—, —CH₂O—, —OCH₂O—, —O(CH₂)₂O—, —COCH₂—, and methylene.

13. The liquid crystal medium composition as claimed in claim 1, wherein the linking group L3 in the Formula (2) is selected from the group consisting of a carbon-to-carbon bond, —O—, —COO—, —OCO—, —CH₂O—, —OCH₂O—, —O(CH₂)₂O—, —COCH₂—, and methylene.

14. The liquid crystal medium composition as claimed in claim 11, wherein the structure of the core group X is selected from the following group consisting of: 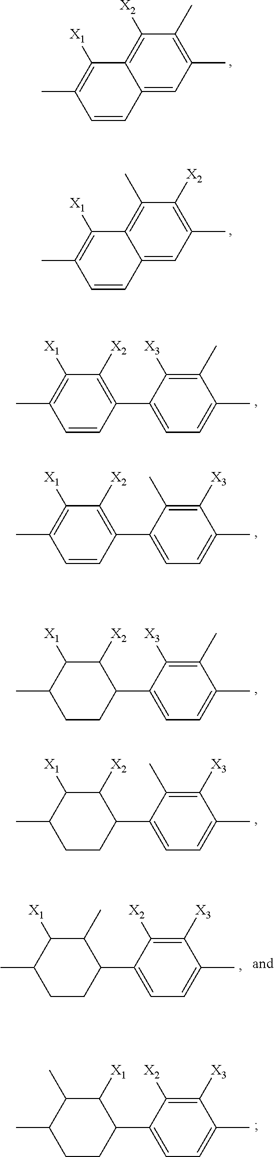
in the above structures, X1, X2, and X3 of the core group X are substituent groups, the substituent group X1 is selected from the group consisting of H, F, Cl, Br, CN, and methyl; the substituent group X2 is selected from the group consisting of H, F, Cl, Br, CN, and methyl; and the substituent group X3 is selected from the group consisting of H, F, Cl, Br, CN, and methyl.

15. The liquid crystal medium composition as claimed in claim 1, wherein the structure of the stabilizer is shown in the following formula: 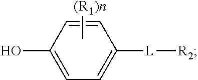
in the above formula, R₁ is a straight chain alkyl or branched alkyl having 1 to 9 carbon atoms, n is an integer ranging from 1 to 4; when n>1, there are many substituent groups R₁ of same structure or different structures in each of ring structure, R₂ is a straight chain alkyl or branched alkyl having 1 to 36 carbon atoms, and L is selected from the group consisting of a carbon-to-carbon bond, —O—, —COO—, —OCO—, —CH2O—, —OCH2O—, —O(CH2)2O—, —COCH2-, and methylene.

16. The liquid crystal medium composition as claimed in claim 1, wherein the liquid crystal material comprises at least one kind of liquid crystal molecule having structure shown in the following formula: 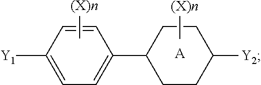
in the above formula, 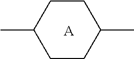
can be 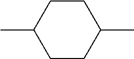
or 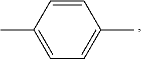
X is the substituent group connected to the ring structure, and n is an integer ranging from 1 to 4; n is varied in different ring structures; when n>1, there are many substituent groups X of same structure or different structures in each of ring structure; the substituent group X is selected from the group consisting of —H, —F, —Cl, —Br, —I, —CN, and —NO₂; Y₁ and Y₂ are independently selected from the group consisting of —R, —O—R, —CO—R, —OCO—R, —COO—R, and —(OCH₂CH₂)ₙ₁CH₃; R is a straight chain alkyl or branched alkyl having 1 to 12 carbon atoms; n1 is an integer ranging from 1 to 5, and Y₁ is the same as Y₂ or different from Y₂.

17. The liquid crystal medium composition as claimed in claim 1, wherein the stabilizer comprises component shown the following formula: 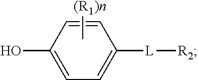
in the above formula, R₁ is the straight chain alkyl or branched alkyl having 1 to 9 carbon atoms, and n is an integer ranging from 1 to 4; When n>1, there are many substituent groups R₁ of same structure or different structure in each of benzene ring structure; R₂ is a straight chain alkyl or branched alkyl having 1 to 36 carbon atoms, and L is selected from the group consisting of a carbon-to-carbon bond, —O—, —COO—, —OCO—, —CH₂O—, —OCH₂O—, —O(CH₂)₂O—, —COCH₂—, and methylene.

18. A liquid crystal medium composition, wherein the liquid crystal medium composition comprises negative type liquid crystal material, the negative type liquid crystal material comprises at least one kind of liquid crystal molecule having structure shown in the following formula: 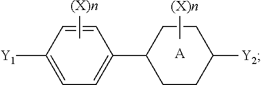
in the above formula, 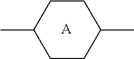
can be 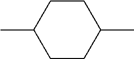
or 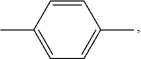
X is the substituent group connected to the ring structure, and n is an integer ranging from 1 to 4; n is varied in different ring structures; when n>1, there are many substituent groups X of same structure or different structures in each of ring structure; the substituent group X is selected from the group consisting of —H, —F, —Cl, —Br, —I, —CN, and —NO₂; Y₁ and Y₂ are independently selected from the group consisting of —R, —O—R, —CO—R, —OCO—R, —COO—R, and —(OCH₂CH₂)ₙ₁CH₃; and Y₁ is the same as Y₂ or different from Y₂.

19. The liquid crystal composition as claimed in claim 18, wherein the substituent group is selected from the group consisting of —H, —F, —Cl, —Br, —I, —CN, and —NO₂.

20. The liquid crystal composition as claimed in claim 18, wherein R is a straight chain alkyl or branched alkyl having 1 to 12 carbon atoms, and n is an integer ranging from 1 to 5.
